(19) United States
(12) Patent Application Publication
(10) Pub. No.: US 2001/0032101 A1
(43) Pub. Date: Oct. 18, 2001

(54) Management system and method for the management of medical data

(76) Inventor: Jan Hendrik Statius Muller, Eindhoven (NL)

Correspondence Address: Corporate Patent Cousel, U.S. Philips Corporation, 580 White Plains Road, Tarrytown, NY, 10591, US

(21) Appl. No.: 09/803,340

(22) Filed: Mar. 9, 2001

(30) Foreign Application Priority Data
Mar. 13, 2000 (EP) 00200887.8

(51) Int. Cl. G06F 17/60

(52) U.S. Cl. 705/2

(57) ABSTRACT

The invention relates to a management system and a method for the management of medical data, notably for the management of medical image data and medical reports. A problem is encountered in that a multitude of medical data that is associated with a given project, for example a patient or a medical case, must be stored and managed in such a manner that it can be retrieved again by means of simple means and that, when necessary, it can be accessed in a fast and simple manner. The medical data, therefore, generally is stored in the form of data sets (8 to 11) which include a plurality of data set elements (71 to 76, 81 to 85), identification codes (711, 752, 831) being assigned to the data set elements (71 to 76, 81 to 85) by means of code generating means (6). According to the invention the identification codes (712, 752, 831) are configured in such a manner that they enable linking to the data sets (8) associated with the data set elements (71 to 76, 81 to 85) and/or to further data set elements (71 to 76, 81 to 85) present in the associated data sets (8). Bar codes (712, 752) are preferably used as identification codes for data set elements (71 to 76) presented in the form of hard copies whereas data set elements (81 to 85) presented in the form of data files are preferably provided with selectable links.

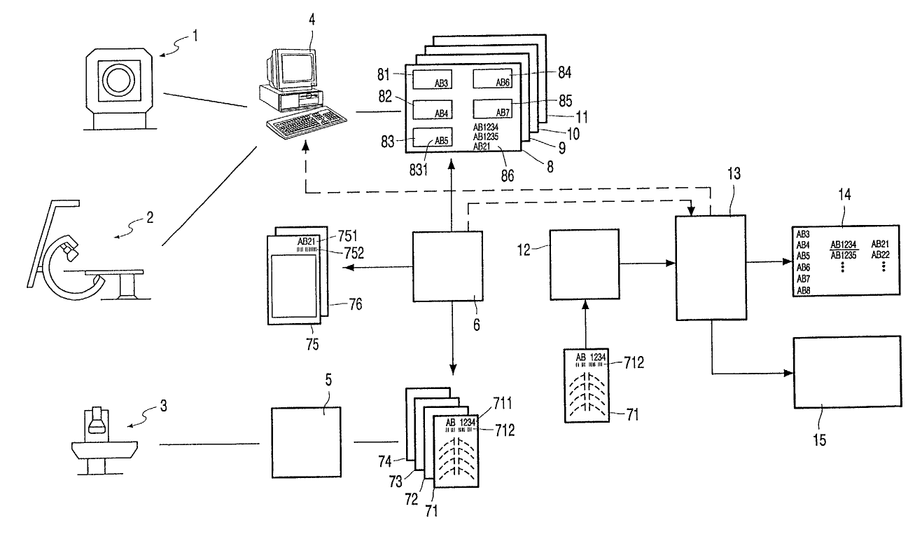

The invention relates to a management system for the management of medical data, notably for the management of medical image data and medical reports, as disclosed in the introductory part of claim 1. The invention also relates to a corresponding method for the management of medical data in conformity with the introductory part of claim 7.

Contemporary medicine has a large variety of diagnostic means available for making a diagnosis of a patient. For example, a physician can make a selection from a variety of imaging methods and devices, for example, magnetic resonance tomography, computed tomography, X-ray and ultrasound techniques, in order to form different images of a patient in conformity with the relevant application. In conventional or older systems such images are usually formed as hard copies, that is, they are printed on paper or are formed by an exposed X-ray film, whereas modern systems deliver digital image data that is stored in digital form on suitable storage media, for example, hard disks, CDs or magnetic tapes. In addition there is usually a variety of other data, such as clinical reports, measuring protocols (for example, EKC print outs) or other information to be linked to a patient. All data that is present in such a variety of forms and is to be assigned to a given procedure or event, for example, a disease or a patient, constitutes a large data set in which each individual image or each series of images, each message and any other information is to be referred to as a data set element.

The publication “Research Disclosure”, February 1993, page 112, describes an image processing system in which medical images are formed by means of different modalities and are printed out as hard copies. Subsequently, a readable code and a machine readable bar code are assigned to each hard copy. Such a bar code contains information as regards the source and the destination of the image, enabling automatic distribution of the image to the intended receiver by means of a distributor in which a bar code reader is provided.

A growing problem is encountered in that ever larger volumes of information must be registered and managed, the information itself being presented in a variety of forms. Particularly for health services it is necessary to ensure the highest degree of carefulness and reliability and in some cases it may also be necessary to ensure anonymity. Therefore, it is an object of the invention to provide a management system for the management of large volumes of medical data which has been improved in respect of said problems. It is also an object of the invention to provide a corresponding method for the management of large volumes of medical data.

These objects are achieved by means of a management system as disclosed in claim 1 and a method as disclosed in claim 7.

The invention is based on the recognition of the fact that for the management of large volumes of medical data that is present in different forms it is essential that means are available for assigning said data to one another, that is, that there is possibility for assigning a data set element to a corresponding data set and linking it thereto. To this end, according to the invention there are provided suitable code generating means and linking means which produce suitable identification codes enabling such assignment or linking of data. The identification codes are configured in such a manner that they are assigned to a data set element independently of its shape, magnitude or other properties and can be read out again while using simple means.

Unlike the known image processing system, the management system in accordance with the the invention is suitable for the management of data presented in any form. The identification codes are not provided for the distribution of data, but rather for the management and linking of the data assigned to a given project. A diagnosis can thus be formed a number of times faster and simpler, because all available data set elements of a data set can be accessed in a manner that is much faster and simpler.

For example, when a radiologist is present in a first department of a hospital during the evaluation of an X-ray image presented in the form of an X-ray film and wishes to consult, before making a diagnosis, additional magnetic resonance tomography images that have been made in a different department and are stored as data sets, the radiologist can read the identification code present on the X-ray film. This leads directly to linking to the data set assigned to this X-ray image and containing the magnetic resonance tomography images. For example, as is disclosed in claim 2, the radiologist can be directly issued a list containing all further data set elements assigned to the same data set. The radiologist can, if desired, and in as far as is disclosed in claim 3, extract this list or have the list of all available data set elements or the data set elements themselves displayed on a display device. This could take place, for example in the form of linkage markers or so-called links as they are known from the Internet. When such a link is clicked on, the corresponding data set element, in as far as it is present in digital form, will be displayed directly.

However, conversely it may also be that a physician makes a diagnosis by means of digital image data displayed on a computer monitor and requires further information. In accordance with the invention an identification code is also assigned to such digital images, for example in the form of the already mentioned links which, when clicked on, cause a list of all other data set elements of the same data sets to be output.

Preferred embodiments concern the configuration of the code generating means or the identification codes and are given in the claims 4 to 6. Bar codes are particularly suitable for application to data set elements presented in the form of hard copies, that is, paper prints, X-ray films or the like. These bar codes are printed either directly on the hard copies or indirectly on labels intended for application (for example, by gluing). Linkage markers (links) that provide further information concerning data set elements of the same data set when clicked on are particularly suitable for data set elements presented in the form of digital data.

The invention will be described in detail hereinafter with reference to a Figure which shows a block diagram of a management system according to the invention.

Medical images are formed by means of various modalities in such a case. The Figure shows, in simplified form, a magnetic resonance tomography unit 1 and a digital subtraction angiography system 2, each of which delivers image data in digital form to an image storage and processing unit 4, being a workstation in the case shown. Moreover, a universal X-ray unit 3 forms X-ray images which, however, are not stored in digital form; instead hard copies 71 . . . 74 are made thereof by means of an X-ray development or printing unit 5.

The data stored in the workstation 4 is assigned to individual data sets 8 to 11, each data set including a plurality of data set elements, the data set elements 81 to 85 of the data set 8 being shown. Moreover, each data set contains a list 86 of further data set elements that are not stored in digital form but are available, for example, as hard copies or in another form. Consequently, a data set 8 contains the data set elements 81 to 85 themselves as well as references 86 to further data set elements, for example X-ray images and examination reports assigned to a given project, an examination, a disease or a patient. In addition to being hard copies 71 to 74, such data set elements that are not available in digital form but are listed on the list 86 may also be medical reports 75 or measuring protocols 76.

There is also provided a code generating means 6 which generates the identification codes to be assigned to the individual data set elements. This means may be formed essentially by an arithmetic unit for generating and managing the identification codes, possibly extended with further sub-units for assigning and applying the codes to the data set elements. The digital data set elements 81 to 85 are thus assigned identification codes 831 which are displayed together with the data set elements; this display takes place in normally readable or in encrypted form. Preferably, the identification codes are formed as links, for example the type of link that is known from the Internet. The data set elements 71 to 76 that are available in the form of hard copies are preferably assigned identification codes 712 and 752 in the form of bar codes which are applied directly to the hard copies; additionally, a readable identification 711, 751 may also be provided thereon.

The management system also includes a reading device 12 that is capable of reading identification codes. Reading can be done on the one hand by reading a bar code 712 of an X-ray image 71 or a bar code 752 of a report 75 by means of a bar code reader. However, it is also feasible that the identification code is entered into the reading device 12 in different form, for example, that it is entered by way of a keyboard so as to be read. The reading device also includes means which are capable of detecting that the identification code (for example, 831) associated with a digital data set element (for example, 83) is selected, for example by clicking on by means of a computer mouse. When such an identification code 831) is selected, it is also read so as to be further processed. It may also be that a symbol appears on the display instead of the identification code itself; such a symbol symbolizes the possible linkage to the associated data set and the hidden identification code is read internally upon selection thereof.

The result of this read or selection operation is subsequently applied to a linking means 13 in which the linking to the data set with which the data set element bearing the relevant identification code is associated is performed on the basis of the identification code. To this end, the linking means 13, which may be implemented as a conventional computer, is supplied with all data, generated by the code generating means 6, as to which identification codes were generated and to which data set elements they are assigned in which data sets. Moreover, it has also received the information as to where said data set elements are situated.

For example, when a physician views the X-ray image 71 and requires further information concerning the same patient, the physician can read the bar code 712 by means of the reading device 12. On the basis of the identification code 712 the linking means 13 then finds out that this data set element 71 is associated with the data set 8 and displays a list of all further data set elements associated with the data set 8 on a display device 14. There may also be provided a further display device 15 on which one or more of these data set elements can be displayed at the same time; to this end, the linking means 13 can also access the memory unit 4. The physician can thus base his diagnosis not only on the X-ray image 71 which is a static image with a high contrast and a high resolution, but also on digital images or image sequences that, notably because of their dynamic nature, contain more information, be it generally with at a lower resolution and less contrast.

The management system in accordance with the invention notably enables more complex diagnoses to be made faster and simpler, because a larger amount of information becomes available to the physician within a shorter period of time. The management system in accordance with the invention constitutes a simple possibility for managing large quantities of medical data, the user nevertheless being ensured ease of handling.

The invention is by no means restricted to the embodiment shown. Many alternative versions are feasible in respect of the actual construction of the means used. It is particularly to be noted that the invention is not restricted either to a special type of data or to special configurations of data.

1. A management system for the management of medical data, notably medical image data and medical reports, which system includes a memory (4) for storing the medical data in the form of data sets (8 to 11) which include a plurality of data set elements (71 to 76, 81 to 85), code generating means (6) for generating and assigning identification codes (712, 752, 831) to data set elements (71 to 76, 81 to 85), and also a reading device (12) for reading the identification codes (712, 752, 831),
characterized in that the code generating means (6) are arranged to generate identification codes (712, 752, 831) which enable linking to the data sets (8) associated with the data set elements (71 to 76, 81 to 85) and/or further data set elements (71 to 76, 81 to 85) present in the associated data sets (8), and that linking means (13) are provided for linking data set elements (71 to 76, 81 to 85) to the associated data sets (8) on the basis of the identification codes (712, 752, 831).

2. A management system as claimed in claim 1,
characterized in that the linking means (13) are arranged in such a manner that when an identification code (712, 752, 831) is read, information is output concerning further data set elements (71 to 76, 81 to 85) present in the associated data set (8).

3. A management system as claimed in claim 1,
characterized in that the linking means (13) are -arranged in such a manner that when an identification code (712, 752, 831) is read, one or more data set elements (71 to 76, 81 to 85) of the associated data set (8) are displayed on a display device (16).

4. A management system as claimed in claim 1,
characterized in that the code generating means (6) are arranged to generate and apply the identification codes (712, 752) to the data set elements (71 to 76) in the form of hard copies, notably to medical images or reports presented as hard copies, in a machine readable form, notably in the form of a bar code.

5. A management system as claimed in claim 4,
characterized in that the code generating means (6) are arranged for the direct or indirect application of the identification codes (712, 752) to the data set elements (71 to 76) presented as hard copies, notably by printing on the hard copies or by applying labels to the hard copies.

6. A management system as claimed in claim 1,
characterized in that the code generating means (6) are arranged to generate and assign identification codes (831), particularly in the form of readable and selectable links, to data set elements (81 to 85) presented in the form of digital data, notably in the form of data files.

7. A method for the management of medical data, notably medical image data and medical reports, wherein the medical data is stored in the form of data sets (8 to 11) which include a plurality of data set elements (71 to 76, 81 to 85) and wherein identification codes (712, 752, 831) are associated with the data set elements (71 to 76, 81 to 85),
characterized in that the identification codes (712, 752, 831) are generated in such a manner that they enable linking to the data sets (8) associated with the data set elements (71 to 76, 81 to 85) and/or to further data set elements (71 to 76, 81 to 85) present in the associated data sets (8).
